(19) United States
(12) Patent Application Publication
(10) Pub. No.: US 2010/0269735 A1
(43) Pub. Date: Oct. 28, 2010

(54) Composition Based on Phosphatic Raw Materials and Process for the Preparation Thereof

(76) Inventors: Martin Shichtel, Dudweiler (DE); Jörg Jodlauk, SR., Sulzbach (DE)

Correspondence Address: PILLSBURY WINTHROP SHAW PITTMAN, LLP, P.O. BOX 10500, MCLEAN, VA, 22102, US

(21) Appl. No.: 12/677,495

(22) PCT Filed: Sep. 5, 2008
(86) PCT No.: PCT/EP08/61774

§ 371 Date: Jul. 2, 2010

(30) Foreign Application Priority Data
Sep. 10, 2007 (DE) 10 2007 042 669.2

(51) Int. Cl. C04B 28/00

(52) U.S. Cl. 106/691; 106/690

(57) ABSTRACT

The invention relates to a composition comprising an inorganic phosphatic binder and fillers with a high specific surface area, the use thereof and the preparation thereof.

### PRIORITY

The present application claims priority to, and is the U.S. National Stage, under 35 U.S.C. §371, of International Application PCT/EP2008/061224, filed Sep. 5, 2008, which claims the priority of German Application DE 10 2007 042 669.2, filed Sep. 10, 2007, the entire contents of each priority document is hereby incorporated by reference for all purposes.

### FIELD OF THE INVENTION

The invention relates to a composition comprising an inorganic phosphatic binder and fillers with a high specific surface area, the use thereof and the preparation thereof.

### BACKGROUND OF THE INVENTION

Concrete is an artificial rock made from cement (hydraulic binder), aggregate and mixing water. Further, concrete additions and admixtures may be added to this mixture. The key material is the hydraulic binder, whose composition is to ensure the respectively best possible combination of desired product properties. Cements having a wide variety of properties are known. This mainly calcium silicate with fractions of aluminum and iron is usually in the form of a complicated mixture. Upon the addition of mixing water, this inorganic, non-metallic solid solidifies by itself due to chemical reactions. Cement will react by absorption of the mixing water (also in a humid atmosphere) to form calcium silicate hydrates, which form fine needle-shaped crystals, which will interlock and thus give high strengths.

For example, Portland cement is prepared by milling together clinker and gypsum or anhydrite, consisting of about from 58 to 66% of calcium oxide, from 18 to 26% of silicon dioxide, from 4 to 10% of aluminum oxide and from 2 to 5% of iron oxide. These materials go through a firing process in a rotary kiln, during which minerals of critical importance to the particular properties of cement form from these components. The most important of these compounds are tricalcium silicate (3CaO.SiO₂), dicalcium silicate (2CaO.SiO₂), tricalcium aluminate (3CaO.Al₂O₃) and tetracalcium aluminate ferrite (4CaO.Al₂O₃.Fe₂O₃). Along the way, this process also results in a high carbon dioxide load. The preparation of about 1.4 billion tons of cement per year (2005), which contains 60% CaO on average, involves an annual CO₂ emission of about 1 billion tons of carbon dioxide, which adds 4% per year to the total CO₂ balance (source: Carbon Dioxide Information Analysis Center).

In addition to its chemical and mineralogical composition, the fineness of a cement is also critical to its properties. Finer cements generally provide higher strengths. This “fineness” is in a direct relationship with the specific surface area of the material, which is often between 2500 and 5000 cm²/g. The standard EN 197 makes a distinction between three different strength classes (32.5, 42.5 and 52.5 MPa), which is in turn classified into slower and faster curing (r=rapid) cements and comprises five different types (CEM I=Portland cement, CEM II=Portland composite cement, CEM III=blast-furnace cement, CEM IV=pozzolanic cement, CEM V=composite cement).

After the addition of the mixing water, various reactions proceed in this hydraulic binder, resulting in the setting and curing of the cement, in particular. Water-containing compounds are formed. The cement generally reacts in a relatively low-water plastic mixture with water to cement ratios of about from 0.3 to 0.6. This hydration causes the cement paste to stiffen. When the stiffening exceeds a particular grade, it is referred to as “setting”. The hardening that proceeds subsequently is called “curing”.

The cause of the stiffening, setting and curing is the formation of a more or less rigid texture of hydration products, which fills up the water-filled space between the solid particles of the cement paste, mortar or concrete. A fixed reference value for this is the water to cement ratio, which defines the course in time of the hydration rather than the kind of hydration products as a function of the size of the interstice. The strength-forming hydration products are primarily calcium silicate hydrates in the silicate cements, and calcium aluminate hydrates in alumina cement. Other hydration products include calcium hydroxide, calcium ferrite hydrates, sulfate-containing hydrates and related compounds, such as hydrogarnet. The calcium silicate hydrates are of particular importance.

Shortly after the first contact with water, a short and intensive hydration starts. From the reaction of calcium and sulfate ions with tricalcium aluminate, short hexagonal columnar ettringite crystals form on the surfaces of the clinker particles. In addition, starting from tricalcium silicate, there is formation of the first calcium silicate hydrates (CSH) in a colloidal form. Due to the formation of a thin film of hydration products on the clinker particles, this first hydration period subsides, and the rest period or induction period begins, during which virtually no further hydration takes place. The first hydration nuclei are too small to bridge the space between the cement particles and to build up a solid texture. Thus, the cement particles remain mobile relative to one another, i.e., the consistency of the cement paste has become only slightly stiffer. The setting of the cement paste starts after about one to three hours when the first, still very fine calcium silicate hydrate crystals form on the clinker particles.

After completion of the rest period, intensive hydration of the clinker phases starts again. This third period (acceleration period) begins after about four hours and ends after 12 to 24 hours, building a basic texture consisting of CSH fiber bundles or CSH sheet structures, plate-like calcium hydroxide and longitudinally growing ettringite crystals. The larger crystals bridge the spaces between the cement particles. In the further course of the hydration, the strengthening continues to increase, but at a reduced hydration rate. The texture is compacted thereby, and the pores are increasingly filled. The chemical reactions of the clinker phases with the mixing water can be represented in a simplified way as follows:

2 (3CaO.SiO₂)+6H₂O→3CaO.2SiO₂.3H₂O+3 Ca(OH)₂

2 (2CaO.SiO₂)+4 H₂O→3CaO.2SiO₂.3H₂O+Ca(OH)₂

3CaO.Al₂O₃+12 H₂O+Ca(OH)₂→4CaO.Al₂O₃.13H₂O

4CaO.Al₂O₃.Fe₂O₃+13 H₂O→4CaO.Al₂O₃.Fe₂O₃.13H₂O

The hydration products do not form simultaneously, but at different rates and after different times in accordance with the respective reactivities. The transition from setting to curing is “smooth”.

In combination with further fillers, the concrete is formed in this way and usually develops its final strength within 28 days. In addition to the early strength that forms, an essential property of the concrete is its freedom from cracks and thus, shrinkage as low as possible upon curing and a good chemical resistance. For the latter characteristic, a correspondingly dense and crack-free concrete that also has a low gas permeability is to be prepared. However, with such a concrete, compromises with respect to the early and final strengths must be made. This is directly related to the formation of the pore space. Defects from drying out, shrinkage and autogenous shrinkage may occur already in the setting phase.

In later phases, the bound hydrate water can expand and in part even crack the pore structure at low temperatures by the formation of ice. Further, there is a high risk of corrosion for steel reinforcements when the compaction and pretreatment are insufficient. Conversely, at increased temperatures, for example, between 100° C. and 250° C., in part even at 80° C., dehydration of the texture begins. This causes a drop of strength of up to 25% of the overall strength. The disadvantages from the preparation of concrete are many, including poor tensile strength, low chemical stability (especially acid stability), losses of strength in aggressive environments (for example nuclear power plants) as well as poor colorability, tendency to bloom and a strong dehydration tendency, in addition to the losses of properties stated above.

DE 2621110 describes the use of cellular glass bodies, which are reacted with metaphosphate, the glass and phosphate reacting as acid and base in some kind of salting out effect.

DE 2900191 describes phosphate-containing silicate foams, wherein water glass is reacted with phosphate, and the phosphate is the curing agent rather than the matrix.

DE 4434627 C1 describes a two-component silicate glue, wherein phosphate is the curing agent.

DE 3242352 A1 describes aluminum silicates and the preparation thereof under some pressure and an elevated temperature, wherein the silicate is the matrix and aluminum is the dope.

DE 3006551 describes a potassium silicate cement in which aluminum phosphate is employed as the curing agent, and a silicate material is the basis.

### SUMMARY OF THE INVENTION

It is the object of the invention to find a mixture of materials that includes phosphatic binders rather than hydraulic binders, yielding stable and thoroughly cured molded parts at temperatures of below 121° C. (even in admixture with fillers and processing aids).

It is another object of the invention to provide new concrete mixtures based on phosphatic binders as the binder phase that are suitable for the preparation of, for example, molded parts and have improved properties over the prior art, for example, an increased material density, lower pore volume, high chemical resistance, extremely high compressive strength, enhanced tensile strength (even without fibers).

### DETAILED DESCRIPTION OF THE INVENTION

In a first embodiment, the object of the invention is achieved by a composition comprising a binder that at least partially consists of an inorganic phosphatic binder, and active fillers, wherein the latter have a specific surface area of more than 8 m²/g and have an oxidic, hydroxidic or oxidic-hydroxidic surface.

Thus, this object is achieved by the composition having the features of claim 1. Preferred embodiments and further embodiments of the invention are stated in the dependent claims.

The composition according to the invention can be interpreted as a concrete composition, since it can be employed and prepared in a similar way in principle. From a chemical point of view, however, a phosphatic inorganic binder is employed rather than a cement, for example.

An oxidic, hydroxidic or oxidic-hydroxidic surface within the meaning of the invention means that the surface is substantially oxidic, hydroxidic or oxidic-hydroxidic in nature. For example, the surface is at least 90% oxidic, hydroxidic or oxidic-hydroxidic in nature.

In order to be able to solve the problem of the invention in a reasonable way, one has to refrain from the original definition of concrete: concrete [from Latin “concretus”, meaning “compact” or “condensed”] is a composite construction material consisting of binders (e.g., cement, bitumen, silicate, clay), aggregates (e.g., gravel, rock, crushed rock) and water. In the case of the present invention, the binders must be extended by the group of phosphatic binders. However, this is not intended to mean the group of phosphate cements employed in dentistry. The phosphate cements used in dentistry are usually a mixture of 80-90% zinc oxide, 10% magnesium oxide, 6% calcium fluoride, 4% silicon oxide and 1% aluminum oxide, 45% of this mixture being blended with 55% phosphoric acid. Already because of the concentrated mineral acid, such a material cannot be employed in practice on construction sites or plants.

Therefore, the objective of the development of a new composition based on phosphatic raw materials and of processes for the preparation thereof was the development of an alternative material that can be used in critical fields and does not exhibit negative properties such as a tendency to bloom, poor tensile strength, poor chemical stability etc. This is achieved by replacing hydraulic binders by three-dimensionally chemically cross-linking inorganic phosphate binders.

With the compositions according to the invention based on phosphatic raw materials, concrete analogues can be prepared without the typical negative properties of concrete (for example, low tensile strengths of non-fiber-reinforced concretes, loss of strength at temperature, efflorescence phenomena etc.) that arise from its hydraulic binder. A fundamental and most important distinctive feature is the strengthening. The phosphatic binders react with physical interlock of the salts, or more advantageously by condensation reactions, and form a stable inorganic three-dimensional network. Therefore, the invention describes a possibility to prepare concrete without hydraulic binders by using phosphatic binders. Due to the chemical and physical properties of the new binders, the simplest mixtures can now be employed to solve complex constructive problems, especially in safety-relevant fields.

The composition according to the invention, such as a phosphate concrete, can be controlled in its properties by a wide variety of further raw materials. In addition to additives and fillers, specific foaming agents and curing agents may be contained in the composition, so that the composition according to the invention, such as a phosphate concrete, is a versatile material that can be employed for many applications.

“Phosphatic binders” preferably means alkali phosphates, polymer alkali phosphates, silicophosphates, monoaluminum phosphate, borophosphate, magnesium sodium phosphate, alkali silicophosphate, phosphate glass, zinc phosphates, magnesium phosphates, calcium phosphates, titanium phosphates, chromium phosphates, iron phosphates and manganese phosphates. However, the only use of such phosphates will not provide the desired effect of curing at temperatures of below 121° C. Temperatures of below 121° C. only result in the evaporation of the water and formation of a salt crust. The fillers according to the invention are obligatory. Therefore, phosphatically based coatings are usually formed at significantly higher temperatures, as clearly shown in WO 01/87798 A2, DE 600 02 364 T2 or U.S. Pat. No. 3,775,318. More preferably, the phosphatic binder at least partially consists of a monomer, oligomer and/or polymer, for example, of monoaluminum phosphate.

The phosphatic binders as a matrix produce a high chemical resistance and acid resistance.

The phosphatic binder within the meaning of the invention is preferably a polymerizable inorganic phosphate compound. This provides the composition with a particularly high strength after curing.

Therefore, the preparation of the new concrete or concrete-like materials on the basis of new compositions based on phosphatic binders also requires a completely new concrete chemistry.

The relevant component is the phosphatic binder selected from the above mentioned group. Without any confirmed knowledge, it is assumed that the binder undergoes a transition from the monomeric to the polymeric state by condensation reactions, thus strengthening the constructional part. This strengthening process is initiated or even catalyzed by surfaces having a large specific surface area and in part being slightly acidic, as can be found, for example, in various nanoparticulate or even amorphous and partially crystalline systems. In order to set the reaction equilibrium accordingly, the excess water must be carried off as the reaction proceeds, which usually occurs already by its own vapor pressure. The value of the preferred specific surface areas of the fillers according to the invention is within a range of from 120 m²/g to 250 m²/g. In these ranges, the viscosity parameters, in particular, which ultimately define the kind of concrete, i.e., whether it is gunned concrete, in-situ concrete, ready-mixed concrete etc., can be adjusted best. Higher specific surface areas show neither advantages nor disadvantages with respect to the curing of the phosphatic system. The inventors have found that the minimum content of particles having the appropriate specific surface areas is not a critical factor for the overall composition, and that the effect according to the invention can be achieved even with compositions having contents of particles having a high surface area as low as from 0.2 to 0.5% by weight.

In addition to the curing at temperatures of below 121° C., the compositions according to the invention adapted to the specific application exhibit additional advantages, such as low porosity, zero shrinkage, compressive strength or a significantly increased tensile strength.

These are explained by the fact that, instead of slowly forming needles like with usual concrete so that the final strength is achieved in part only within 28 days, a three-dimensional chemical binder network is formed by the polymerization reaction.

A preferred binder from the group of alkali phosphates, polymer alkali phosphates, silicophosphates, monoaluminum phosphate (MAP), borophosphate, magnesium sodium phosphate, alkali silicophosphate, phosphate glass, zinc phosphates, magnesium phosphates, calcium phosphates, titanium phosphates, chromium phosphates, iron phosphates and manganese phosphates is monoaluminum phosphate (MAP). It is advantageous to employ the MAP as a 50% to 60% solution. Powder mixtures provided with water afterwards are also possible. Suitable as particles having a high specific surface area are, in particular, systems with hydroxidic surfaces, such as extremely finely divided aluminum oxide, aluminum hydroxide, titanium oxide, cerium oxide, iron oxide as well as zinc, tin or zirconium oxides. Mixed oxides may also be employed.

Surprisingly, sols from the group of acidically stabilized sols, such as silica sol, aluminum sol, titanium sol, etc., proved suitable for reducing the pore structure and for adjusting further properties. Generally, all extremely finely divided particle systems (with the corresponding surface area) known to the skilled person can be used to run the reaction, and all sols known to the skilled person can be used to adjust various properties.

The composition of the remaining fillers primarily depends on the desired application and economic efficiency.

The fillers preferably have a specific surface area of at least 60 m²/g, more preferably greater than 100 m²/g. Irrespective of this, the fillers preferably have a specific surface area of up to 200 m²/g.

The BET surface area can be measured by means of the measuring device Micromeritics ASAP 2010 according to the standard DIN 66131 or DIN 66132.

For example, by using suitable fillers, such as pigments, dyes, dusting phases, additives, organosilicon compounds etc., the system according to the invention can be functionalized within wide limits.

The fillers are preferably inert and/or basic fillers. Inert fillers usually serve for cost reduction, but may also be employed for the preparation of lightweight phosphate concretes, for example. This group includes materials like quartz (the grain size depends on the particular application), brick dust and powdered porcelain, minerals like cristobalite, muscovite or biotite, oxides like aluminum oxide or zirconium oxide, corresponding oxide-hydroxides, as well as other inert fillers, such as borate glass or silicon carbides.

Fillers within the meaning of the invention may also be, for example, natural materials, such as fibers (for example, wood fibers, hemp, sisal, nettle etc.), meals or granules (for example, wood or cork). The fibers may also be, for example, artificial fibers, such as glass fibers (no special glass fiber necessary, all commercially available types can be employed), carbon fibers or, for example, Kevlar fibers.

Many other fillers including those employed in standard concrete production may also be employed. Advantageously, carbides, such as boron carbide and titanium carbide etc., or nitrides, such as boron nitride or aluminum nitride, or the like can be incorporated. The particle sizes and surfaces are less relevant than those of the initiator particles.

For example, fillers may also consist of basic materials, such as aluminum nitride or boehmite, which have a strengthening and thus “reactive” effect due to their slightly basic character.

The composition according to the invention preferably contains:
from 5 to 40% by weight of inorganic phosphatic binder;
from 15 to 30% by weight of water; and
from 30 to 80% by weight of active fillers and/or additives.

As compared to the previously known concrete compositions, this has the advantage, for example, that a completely curing composition can also be provided with a substantially lesser a mount of binder, which is conventionally cement.

The inorganic phosphatic binder is preferably contained in a proportion of from 10 to 30% by weight.

The composition preferably contains less than 50% by weight, especially less than 10% by weight, of calcium oxide. In this case, it seems that the phosphatic binder is better capable of curing the composition. Namely, it has been surprisingly found that the composition cures in an uncontrolled way by calcium oxide. At the sites where the calcium oxide crystals occur, an immediate aggregation was observed.

The composition preferably contains less than 50% by weight, especially less than 10% by weight, of zinc oxide. In this case, it seems that the phosphatic binder is better capable of curing the composition.

During the development of the composition according to the invention, such as a composition for phosphate concretes, it was surprisingly found that various substances can be employed as curing agents or catalysts for curing or accelerated curing. Therefore, fluorides as curing agents and/or basic curing agents (for example, frits, glaze powders, basic oxides and/or water glass) are also advantageously contained in the composition according to the invention. With these curing agents, it is also unimportant whether they are new, freshly synthesized materials or recyclates. Thus, for example, zinc oxide (from the group of basic oxides) can be employed as well as various water glasses independently of the type of water glass. Ceramic raw materials, such as frits and glaze powders, are to be considered by analogy. The curing agent is advantageously contained in an amount within a range of from 0.1 to 30% by weight in the composition according to the invention. Advantageously, the curing agent is not or does not contain CaO.

For example, a zirconia frit will cure the composition according to the invention, such as a phosphate concrete, within 24 hours, whereas a borosilicate frit or a calcium borate frit provides for immediate curing and thorough curing within 8 hours.

A wide variety of curing agents is offered, for example, by the group of basic rock meals, such as feldspar, olivine or basalt.

For example, if a 50/50 (parts by weight) mixture of MAP (monoaluminum phosphate) and basalt is employed, the phosphate concrete will cure to completion within 48 hours, but exhibits a narrow processing window of about 60 minutes. If the mixture is varied to 75/25, the overall reaction time is retained whereas the working window is broadened by up to 800%. If the formulation is varied into the opposite direction (33/67), the curing is complete within 8 hours, but with a processing time of about 15 minutes.

Feldspars, such as nepheline syenite, significantly reduce the curing time until the final strength is reached. A 50/50 mixture of MAP/feldspar will cure within 24 hours to the final strength, with a processing window of 10 minutes. Variation to 90/15 retains the curing time and significantly extends the processing time (about 60 minutes).

A 50/50 mixture of MAP/olivine will cure within 4 days and shows a processing window of 2-3 hours.

Extremely short curing times were observed when sodalite was employed.

Advantageously, inhibitors are also contained in the composition according to the invention within a range of from 0.01 to 5% by weight. The reaction parameters, especially the free pot life/processing time, can be controlled by corresponding inhibitors, and therefore, formulations for ready-mixed concrete, for example, can also be prepared. These may be usual inhibitors from known concrete compositions.

Preferably, lightweight materials are also contained in the composition according to the invention within a range of from 1 to 30% by weight, especially within a range of from 10 to 25% by weight. By using suitable lightweight materials, such as styrofoam, glass bubbles or EPS foam spheres, compositions according to the invention, such as phosphate lightweight concretes, having densities of around 0.3 g/cm³ can be achieved. The lightweight materials may further be used for applications in the field of acoustic and thermal insulation. By a simple reformulation, heat-insulating materials may also be employed as fire protection plates or casting compositions, since the matrix has a temperature stability of from 1500° C. to 1800° C. among others.

On the other hand, it may also be preferred that the composition according to the invention contains heavy materials within a range of from 1 to 30% by weight, especially within a range of from 10 to 25% by weight. The use of lead, iron oxides and similar heavy materials enables compositions according to the invention, such as phosphate heavy concretes, having densities of up to 3.6 g/cm³.

The composition according to the invention may advantageously also contain additives, such as liquefiers, gel formers, thixotropizing agents, foaming agents etc. More preferably, reaction accelerators and/or reaction retarders are contained. For example, boric acid, certain mineral acids (phosphoric and hydrochloric acids) and acidic clays act as reaction retarders, which can have an effect on both the processing and the curing. The same applies, mutatis mutandis, to reaction accelerators, for example, sulfuric acid, sulfides, borides, but also clay and related materials.

In the composition according to the invention, carbonate-containing materials, such as dolomite or lime, are also advantageously contained as additives, because concrete foams can be quite readily prepared thereby, and may be varied in terms of bubble size, open cell or closed cell property by varying the concentration, addition of micelle forming agents, stabilizers etc.

Due to a large number of positive parameters clearly superior to the prior art, the invention is suitable for various applications, such as lightweight concrete, heavy concrete, fiber-reinforced concrete, high strength concrete, ultrahigh strength concrete, insulating concrete, radiation protection concrete etc.

In another embodiment, the object of the invention is achieved by the use of the composition according to the invention for preparing cured concrete, plaster, jointing filler, concrete restoration, screed, mortar, foam or inorganic adhesive.

In another embodiment, the object of the invention is achieved by a process for preparing a concrete molded part by curing the composition according to the invention.

In another embodiment, the object of the invention is achieved by a concrete molded part containing an inorganic phosphatic binder and fillers having a specific surface area of at least 60 m²/g.

The concrete molded part preferably contains less than 50% by weight, especially less than 10% by weight, of calcium oxide. In this case, it seems that the phosphatic binder is better capable of curing the composition.

The concrete molded part preferably contains less than 50% by weight, especially less than 10% by weight, of zinc oxide. In this case, it seems that the phosphatic binder is better capable of curing the composition.

The concrete molded part according to the invention is preferably obtained by the process according to the invention.

### EXAMPLES

In the following, Examples and particular variants of the system according to the invention are illustrated.

### Example 1

A first Example had the following composition, in weight percent:
MAP: 40% (40% by weight solution in water)
Cristobalite: 20%
Quartz: 20%
Aluminum oxide: 10%
Boric acid: 2%
Coloring bodies: 8%

Specimens according to DIN 1045-1:2001-07 were prepared for determining the strength classes. The strengthening of the composition according to the invention occurred within 2 days, rather than over 28 days as usual with concrete. The mechanical characteristics of the above described composition included a compressive strength of 63 N/mm² and a tensile strength of 7.9 N/mm². As per the compressive strength, this composition corresponded to a C60/65 standard concrete, which exhibits a tensile strength of only 4.4 N/mm², however. Another advantage of this specimen was its low thermal conductivity of 1.2 W/m·K, as opposed to 2.1 W/m·K for the C60/65 concrete. The thermal expansion at 80° C. had a value of 5·10⁻⁶ K⁻¹ for a bulk density of 2225 kg/m³. In addition to these properties that were significantly improved over those of standard concrete, the inventors found that compositions based on phosphatic binders could be thoroughly colored with pigments and a large number of dyes without difficulty. Further, due to the absence of pore water and cement stone, efflorescence (CaCO₃) did not occur.

Due to the kind of binder, a high acid resistance could also be seen, which had a very positive effect on the chemical and physical stability when the concrete was employed subterraneously (stability towards overacidified soils and acid rain).

### EXAMPLE 2

Another embodiment of the invention had the following composition:
MAP: 30% (40% by weight solution in water)
Cristobalite: 20%
Hematite: 40%
Boron carbide: 5%
Boron nitride: 5%

After a curing time of 48 hours, a possible composition of heavy concrete having a bulk density of 2.9 kg/dm³ resulted. With this density and by using additives such as boron compounds, the composition according to the invention could also be used as a reactor concrete. This material was particularly positively characterized by the fact that there was no drop of strength due to a loss of water even at elevated working temperatures. With “normal” concrete, this loss in strength is as high as 20 to 25% at temperatures of from 100° C. to 250° C. Since this mechanism does not occur in compositions based on phosphatic binders, the compositions according to the invention could also be employed as a material for reactor pressure vessels in which neutron radiations having a fluence of more than 10¹⁹ neutrons/cm² or gamma rays having a dose of 2·10¹⁴ J/g occurred. Further positive material properties could be achieved without difficulty by correspondingly designing the formulation.

### EXAMPLE 3

### Plaster:

As a particular variant of the mortar, plaster was applied to outer and inner walls and ceilings. The processing type, i.e., whether it is a scraped plaster, a rubbed plaster, trowel line plaster or other variants, or the functionality (e.g., acoustic or heat insulating plaster) could be included additively in such formulations.

The basic properties of building physics (e.g., for inner plasters: absorption of ambient humidity, storing and releasing) were also present in the phosphate plaster in a layer with 1.5 cm thickness.
35% of a 40% by weight MAP solution
5% polyphosphoric acid
15% cristobalite meal (d90<40 μm)
5% spodumene (d50<40 μm)
16% AlN grade B
9% calcium borate frit
10% silica sol lithosol L1540
2% Al powder (d50<5 μm)
2% Arbocel BC 200
1% Culminal MHPC 20000
1% Scotchlite S22
4% water

This formulation could be extended by artificial resin dispersions towards artificial resin and hybrid plasters.

### EXAMPLE 4

Jointing filler:

Jointing fillers or jointing mortars like in this formulation were employed for filling joints and cracks. Due to the high acid stability, the composition described here was suitable, inter alia, for use in bathrooms, kitchens, but also in the waste water field.
40% of a 50% by weight MAP solution 9% aluminum oxide APA05
15% cristobalite meal (d90<40 μm)
5% boehmite (d50<60 nm) 5% boric acid
2% magnesite
3% bone ash (d50<1 μm)
8% Iriodin 9103
3% ZnO (d90<1 μm)
10% Vinapas 4053

### EXAMPLE 5

Concrete with Integrated Corrosion Protection:

The steel reinforcement of steel-reinforced concrete is always subject to a risk of corrosion. An increased corrosion potential is provided by the chloride-containing air on the coast and in the off-shore zone. The chlorine-induced corrosion of the steel reinforcement is a standard situation in these cases. As protective measures, the steels are finished by chromatizing and phosphatizing. In the phosphatizing process, zinc and manganese dihydrogenphosphate are employed.

Due to the phosphatic basic character of the phosphate concrete, these measures were clearly supported. In addition, the usual passivation was also performed in the acidic region. The bound phosphate and the partially proportional phosphoric acid at the same time served as rust converters.
50% of a 60% MAP solution
0.5% sodium glutamate
3.5% polyphosphoric acid
6% silica sol acidic 30%
4% lithium acetate
10% hydroxyapatite
10% zinc phosphate
5% lithium phosphate
28% phonolite from the Westerwald (d50<63 μm)
7% GMW 603 (loam from Wirth Tonbergbau)
4% phosphoric acid

The chlorine-induced corrosion of steel reinforcement could be significantly improved. The corrosion rate was reduced from up to 1000 μm per year (carbonated concrete with high chloride load) and could be reduced to less than 100 μm per year for the phosphate concrete according to Example 5 of the invention.

### EXAMPLE 6

### Adhesives:

Inorganic adhesives are usually constituted of glass basic components, such as SiO₂, Na₂CO₃, B₂O₃ or Al₂O₃, and metallic components, such as nickel, iron, copper or powdered solders. In accordance with the melting temperatures of these substances, the processing temperatures are relatively high.

However, due to the chemical cross-linking, the phosphate concrete according to the invention could also be employed as a cold curing “adhesive” in the composite. The following formulation describes an adhesive that could bond, for example, gypsum plasterboards to wood.
50% of a 46% MAP solution
12% Engelhardt Lumina Russet
3% Scotchlite S22
1% phenolic resin spheres
16% olivine NRII
4% zinc borate
8% of an SiO gel (d90<700 nm; 32% in Dowanol)
3% glycerol
3% fish glue

### EXAMPLE 7

### Fiber-Reinforced Concrete:

For conventional concrete, the selection of fibers is highly limited. For example, only specifically prepared alkali-resistant glass fibers can be employed while normal glass fibers or fabrics cannot. The fibers ultimately serve to increase the tensile strength, reduce the weight or improve the flame retardancy (PP fibers). In addition to simple fibers, complete rovings may also be incorporated.

The Example presents a concrete reinforced by short fibers.
40% of a 50% MAP solution
10% of an SiO gel (d90<700 nm; 32% in Dowanol)
10% basalt fibers 3 mm
10% basalt meal (d50<100 μm)
10% basalt meal 0.5-1.5 mm
5% granite sand 0.1-0.5 mm
2% wollastonite
4% aramide fibers
2% glass platelets 140 μm
7% silicon nitride from SKW Trostberg

The basic composition (without fibers) corresponded to that of a C80/C95 concrete. The cement-containing concrete had a tensile strength of 4.8 N/mm² according to DIN 1045-1. The non-fiber-reinforced phosphate concrete already shows a significantly better tensile strength of 19.8 N/mm² according to DIN 1045-1. With a fiber proportion of 4% aramide fibers and 10% basalt short fibers, the tensile strength was increased to 223 N/mm², a value that is normally achieved only with complete rovings.

### INCORPORATION BY REFERENCE

Throughout this application, various references including publications, patents, and pre-grant patent application publications are referred to. Disclosures of these publications in their entireties are hereby incorporated by reference into this application to more fully describe the state of the art to which this invention pertains. It is specifically not admitted that any such reference constitutes prior art against the present application or against any claims thereof. All publications, patents, and pre-grant patent application publications cited in this specification are herein incorporated by reference, and for any and all purposes, as if each individual publication or patent application were specifically and individually indicated to be incorporated by reference. In the case of inconsistencies the present disclosure will prevail.

1. A composition comprising a binder that at least partially consists of an inorganic phosphatic binder, and active fillers, wherein the latter have a specific surface area of more than 8 m²/g and have an oxidic, hydroxidic or oxidic-hydroxidic surface.

2. The composition according to claim 1, characterized by containing:
from 5 to 40% by weight of inorganic phosphatic binder;
from 15 to 30% by weight of water; and
from 30 to 80% by weight of active fillers and/or additives.

3. The composition according to claim 1, characterized in that said inorganic phosphatic binder is contained in a proportion of from 10 to 30% by weight.

4. The composition according to claim 1, characterized in that the composition contains less than 50% by weight, especially less than 10% by weight, of CaO.

5. Compositions according to claim 1, characterized in that said extremely finely divided fillers are nanoparticles having a mean particle diameter of less than 100 nm.

6. The composition according to claim 1 or 2, characterized in that said phosphatic binder replaces the cement and is selected from the group of alkali phosphates, polymer alkali phosphates, silicophosphates, monoaluminum phosphate, borophosphate, magnesium sodium phosphate, alkali silicophosphate, phosphate glass, zinc phosphates, magnesium phosphates, calcium phosphates, titanium phosphates, chromium phosphates, iron phosphates and manganese phosphates.

7. The composition according to any of the preceding claims, characterized in that said binder essentially consists of monoaluminum phosphate.

8. The composition according to any of the preceding claims, characterized in that said particles having a high specific surface area consist of oxides, hydroxides or oxide-hydroxides of metals selected from the group consisting of aluminum, titanium, zirconium, zinc, tin, cerium or iron.

9. The composition according to any of the preceding claims, characterized in that said inorganic binder system essentially consists of a 40% to 60% by weight monoaluminum phosphate solution or particulate monoaluminum phosphate in the same proportion.

10. The composition according to any of the preceding claims, characterized in that aqueous or solvent-containing sols from the group of silica, aluminum, cerium, zirconium or tin sols are employed to introduce additional properties.

11. The composition according to any of the preceding claims, characterized in that mixtures of natural and/or artificial, compact and/or porous grains, predominantly of mineral nature, are admixed as fillers.

12. The composition according to any of the preceding claims, characterized in that additives from the group of pigments, fibrous additives, organic additives, such as emulsions, inert fillers, such as rock meals, or pozzolanic materials are employed.

13. The composition according to any of the preceding claims, characterized in that the extremely finely divided particles are fixed at the surface of the further fillers by physical and/or chemical coupling.

14. The composition according to any of the preceding claims, characterized in that the water content of the composition is below 40%.

15. Use of the composition according to claim 1 for preparing cured concrete, plaster, jointing filler, concrete restoration, screed, mortar, foam or inorganic adhesive.

16. A process for preparing a concrete molded part by curing the composition according to claim 1.

17. A concrete molded part containing an inorganic phosphatic binder and fillers having a specific surface area of at least 60 m²/g.

18. The concrete molded part according to claim 17, obtained by the process according to claim 16.
